(19) United States
(12) Patent Application Publication
(10) Pub. No.: US 2015/0347627 A1
(43) Pub. Date: Dec. 3, 2015

(54) GOSSIPING FOR DECENTRALIZED INFORMATION SPREADING

(71) Applicant: Axon Al, LLC, Harrisonburg, VA (US)

(72) Inventor: Sven A. Brueckner, Harrisonburg, VA (US)

(21) Appl. No.: 14/722,948

(22) Filed: May 27, 2015

Related U.S. Application Data
(60) Provisional application No. 62/004,597, filed on May 29, 2014.

(51) Int. Cl. G06F 17/30; H04L 29/08

(52) U.S. Cl. CPC G06F 17/30958; H04L 67/10

(57) ABSTRACT

Autonomous computational processes (“agents”) representing application-specific data items (e.g., representations of real-world entities or events, any-media documents, models, etc.) are provided with application-independent methods and data structures to spread information in a global topology even when the agents' ability to sense or communicate with other agents is limited relative to the extent of the overall collection. The invention specifies three agent roles (Gossip Producer, Gossip Sharer, Gossip Consumer) that define three unique agent processes from which the information sharing emerges. Any agent in a given application may execute one or more of these roles at any given time and additional agent movement in the chosen topology aids the information spreading.

### REFERENCE TO RELATED APPLICATION

This application claims priority from U.S. Provisional Patent Application Ser. No. 62/004,597, filed May 29, 2014, the entire content of which is incorporated herein by reference.

### FIELD OF THE INVENTION

This invention relates generally to information processing and, in particular, to a method of indirectly exchanging information among representations of real-world entities or data items according to real-world geography or computational topology representations using autonomous agents within a distributed computing environment.

### BACKGROUND OF THE INVENTION

Gossiping is an information sharing technique used commonly in peer-to-peer (P2P) communications networks (see [1] for an introduction). It enables the spread and decentralized processing of information about individual nodes across a network where each node is limited in its communication to only a small set of neighbors (“peers”). FIG. 1 illustrates such a peer-to-peer communications network, forming two connected graph components.

We discuss traditional P2P gossiping in the example of a leader-election protocol that is used, for instance, to identify and name connected graph components. In this protocol, it is assumed that each node, upon its creation, is assigned a unique identifier (“myID”) in the form of a number (FIG. 2). It also assumes that each node maintains a memory of the lowest-valued ID it has been made aware of thus far (“minID”). Without prior communications, the initial minID value of a node is of course its own myID value.

Gossiping protocols have a continuously repeating inter-node information sharing and intra-node information processing component. A node shares specific information about its own state or the state of other nodes with its neighbors and the receivers of this information process it internally. The frequency with which nodes repeat their sharing with their peers is an (individually) tunable parameter.

In our leader-election example, any node shares with its neighbors its current minID value. Upon receiving a minID value, a node will compare it with its internal minID value and, if the received value is smaller than the currently held one, the node will adopt the received value for its new minID value.

In FIG. 3, we illustrate the first round of sharing of minID values. For easier drawing but without loss of generality, we assume here that all nodes share at the same time (synchronized cycles) and that receivers process all incoming minID values at once. The arrows in the figure show, where messages communicate a lower minID value than held by the receiver. FIG. 4 shows the effect of the node-internal processing of the first round of minID-messages. As a result, the diversity of minID values across the network is reduced (half of the original values are not found any longer). FIG. 4 also illustrates the second round of P2P sharing, where the messages still carry lower minID values forward. The third round (FIG. 5) is the last one that, in the particular network topology of the example, affects the locally-held minID values. Any sharing after that (while the network topology does not change), will no longer affect the pattern of minID values.

In FIG. 6, we illustrate the converged state of the simple P2P leadership election gossiping protocol. All nodes in each sub-graph know the ID of their sub-graph leader by their locally-held minID value and the identified leader nodes (#1 and #8) know that they are the leaders because their myID value matches their local minID value. This network-wide knowledge may now be used in other reasoning or communications protocols that assume a single representative for each connected graph component (e.g., centralized decision making).

FIG. 7 illustrates the three key elements of the gossiping process in P2P networks:
Production: A node extracts information from its local state that should be shared with other nodes. Note that the local and thus, by extension, the shared state may include explicit information about other nodes.
Transfer: A node transfers its shared state to its peers via available communications channels.
Consumption: A node processes a received shared state and updates its local state according to its intra-node processing rules.

### SUMMARY OF THE INVENTION

This invention is directed to the spreading of locally-generated information through a collection of autonomous computational processes (“agents”) embedded in a shared arbitrary topology. Information spreading is realized through sharing (“gossiping”) of memory content of some or all agents in repeated pair-wise interactions, while some or all entities may also act as producers or consumers of memory content at some time or another.

The agents embodying this invention are data structures in computational processes executed by one or many processors on a single or a collection of hardware platforms, where each such data structure references a location in a metric space. Any memory maintained by the agents as part of this invention is presumed to be computer memory (e.g., Random Access Memory (RAM), processor cache, (temporary) files stored on internal or external hard disks, databases). The location of any real-world entity represented by any agent may but does not need to correspond to the physical arrangement of the hardware platforms that execute the agents' repeated decision process.

### BRIEF DESCRIPTION OF THE DRAWINGS

FIG. 1 illustrates Nodes in a Peer-to-Peer Communications Network;

FIG. 2 depicts Arbitrary Node myID Values in the Example;

FIG. 3 illustrates First sharing of minID values. Arrow direction shows where sharing may actually lower the receiver's internal minID value;

FIG. 4 shows the Effect of first sharing on local minID values and arrows indicating where the second sharing still conveys new information;

FIG. 5 illustrates Last sharing round that still changes minID values;

FIG. 6 depicts Sub-graph leaders (#1 and #8) elected in the example;

FIG. 7 shows Three processes that support gossiping;

FIG. 8 illustrates application entities filling the generalized gossiping roles embedded in a shared topology that supports (short-range) communication and, as shown for GS, movement;

FIG. 9 illustrates Process and Interaction Flow (Cyclical GS);

FIG. 10 depicts Process and Interaction Flow (Event-Driven GS);

FIG. 11 shows the Application of Gossiping in Peer-to-Peer Networks;

FIG. 12 represents an Example of Data Flow through Gossiping in a Peer-to-Peer Network; and

FIG. 13 shows how Gossiper Agents Spread Information through Interactions and Movement in Space.

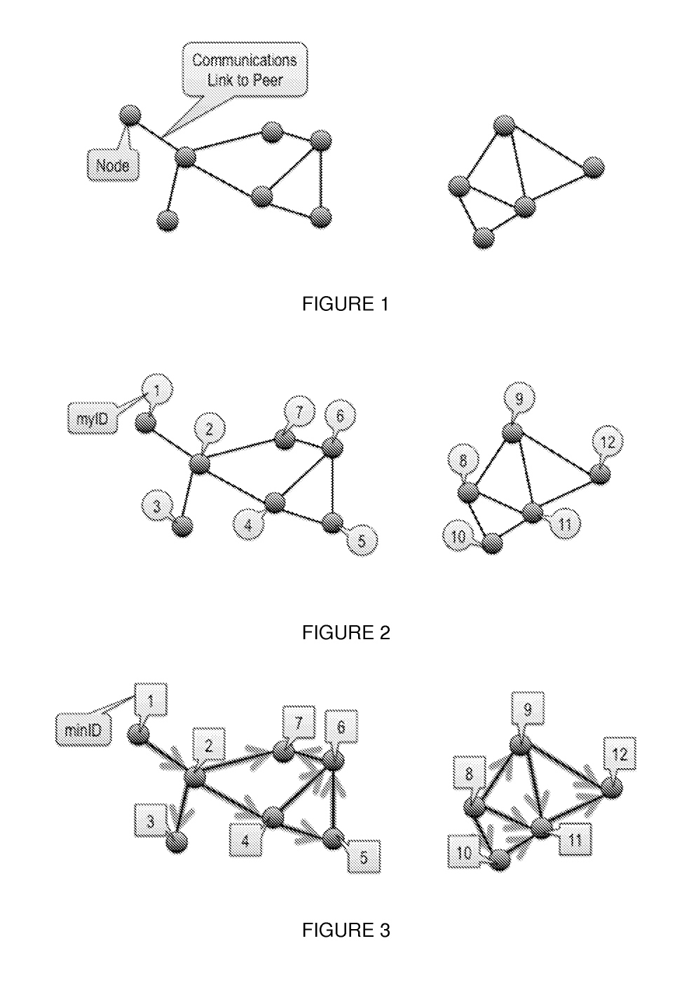

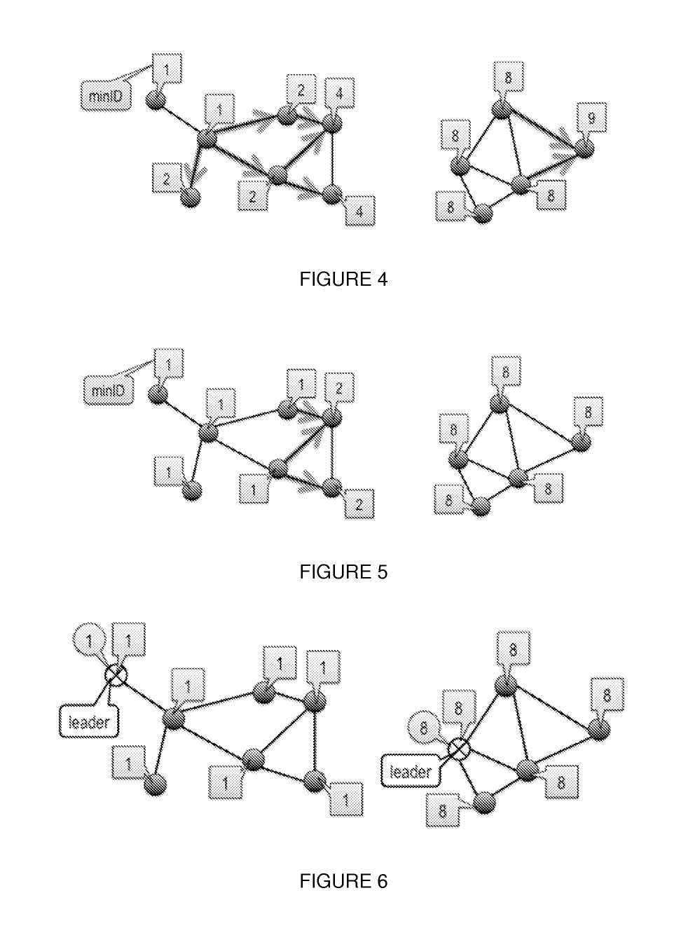

### DETAILED DESCRIPTION OF THE INVENTION

Traditional P2P network gossiping, as discussed in the “Background” section, assumes that there exists a communications infrastructure that enables the nodes of the networks to transfer shared state information directly. The topology of this infrastructure (peer connectivity) may change over time as network nodes join or depart or their connectivity changes, but the basic assumption of direct communication between nodes undergirds all P2P networking models.

This invention generalizes the gossiping approach to serve as a means for information transfer even in environments where the entities that produce and consume shared state information have no means for explicit communication. Instead, we assume that our entities are embedded in a shared arbitrary topology (e.g., metric space, graph topology, grid array) that constrains their ability to perceive and communicate with other entities to a (small) range around their current location in that topology. We also assume that it may be feasible (but not necessarily required) for the entities to move within this embedding topology within some constraints (e.g., limited to links within graph topology).

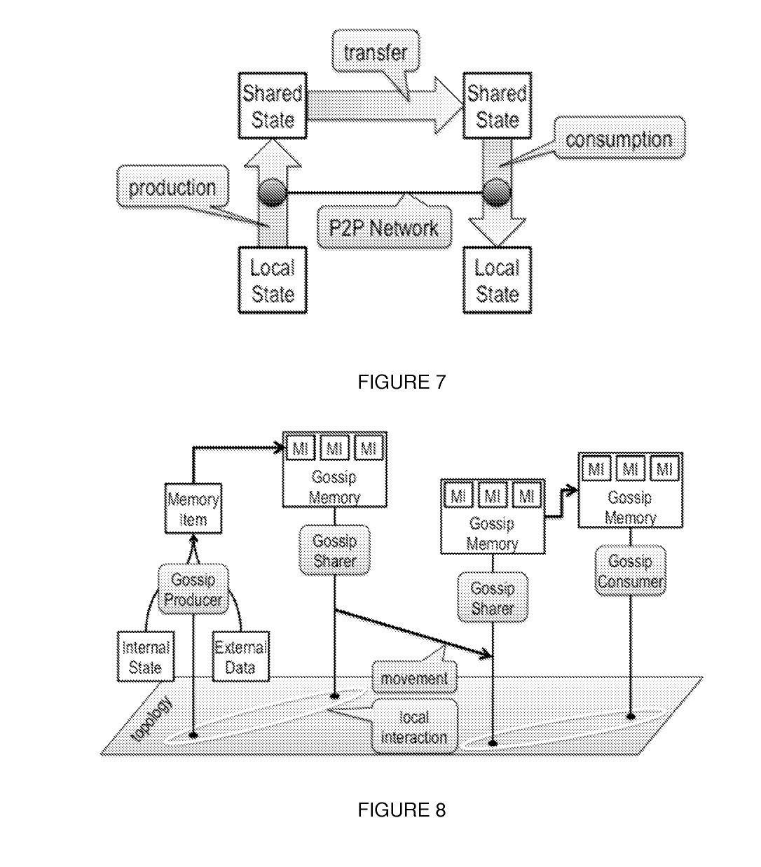

As in FIG. 7, our generalization still maintains the three elements of the gossiping process, which we associate with three roles that may be assumed by the entities that make up a specific application:
Gossip Producer (GP): A GP entity produces, upon request, a “Memory Item” (MI) that contains information that should be shared through gossiping. The MI may contain information about the GP entity itself (as in the “shared state” in the P2P gossiping) or information extracted from the GP's environment (e.g., sensor data).
Gossip Consumer (GC): A GC entity consumes MI that it receives from another entity such that the received information may affect the internal state of the GC entity according to its consumption rules. Specifically, the GC entity maintains a “Gossip Memory” (GM) where it may decide to store new MI it receives.
Gossip Sharer (GS): The GS role extends the GC role with the ability to trigger interactions with Gossip Producers and Gossip Consumers the GS entity perceives in its local topology embedding.
   When interacting with a GP, the GS requests a MI from the producer and then, drawing on its GC role, the GS consumes the MI into its internal state (e.g., GM).
   When interacting with a GC, the GS shares the MI it currently carries in its GM for consumption. Note that since any Gossip Sharer is also a Gossip Consumer, GS share their memory with any other GS (as well as “plain” GC) they encounter in their environment.

For simplicity of this disclosure, our description focuses on a single type of MI that is produced by the GP, stored in the GC's GM, and shared by the GS. But there is no limitation to the number of different types of MI produced, stored, and shared (carrying different types of information across the entity population). And if there are multiple types of MI, the GC may store them all in one common GM or maintain separate memories for each MI type (e.g., to apply different capacity constraints or other memory management schemes). As GP, GC, and GS are defined as specific roles entities may fulfill, we simply assume that these roles are specific to a given MI type and different entities may take on different gossiping roles depending on the type of MI they support.

In FIG. 8, we illustrate the elements of the generalized concept. We show three entities embedded in a shared topology (gray trapezoid with vertical lines from the entities denoting their location) at two different points in time. To the left, there is an entity fulfilling the Gossip Producer role. As another entity with the Gossip Sharer role encounters the GP within the locality defined by the topology, the GS entity triggers an interaction with the GP that results in the creation of a Memory Item by the GP and the storage of the MI in the Gossip Memory of the GS.

Next, the center of FIG. 8 illustrates the movement of the GS in the topology. The rules that determine the GS entity's movement may be defined and executed by the entity itself or a result of external dynamics of the application or its environment. Our generic gossiping process does not make any assumptions in regards to the entities' movement.

Finally, shown to the right in FIG. 8, the GS encounters an entity in its local vicinity that fulfills the Gossip Consumer role. That entity may also be a GS, but for the purpose of this interaction, the GC role suffices to trigger as sharing of the Gossip Memory carried by the GS with the GC it encountered. Thus, even if the Gossip Producer and the Gossip Consumer shown in the figure never encounter each other directly, the GC now may hold an MI from the GP in its GM.

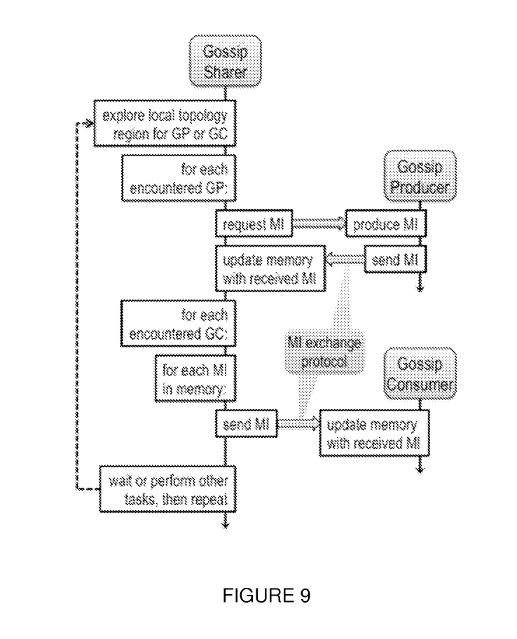

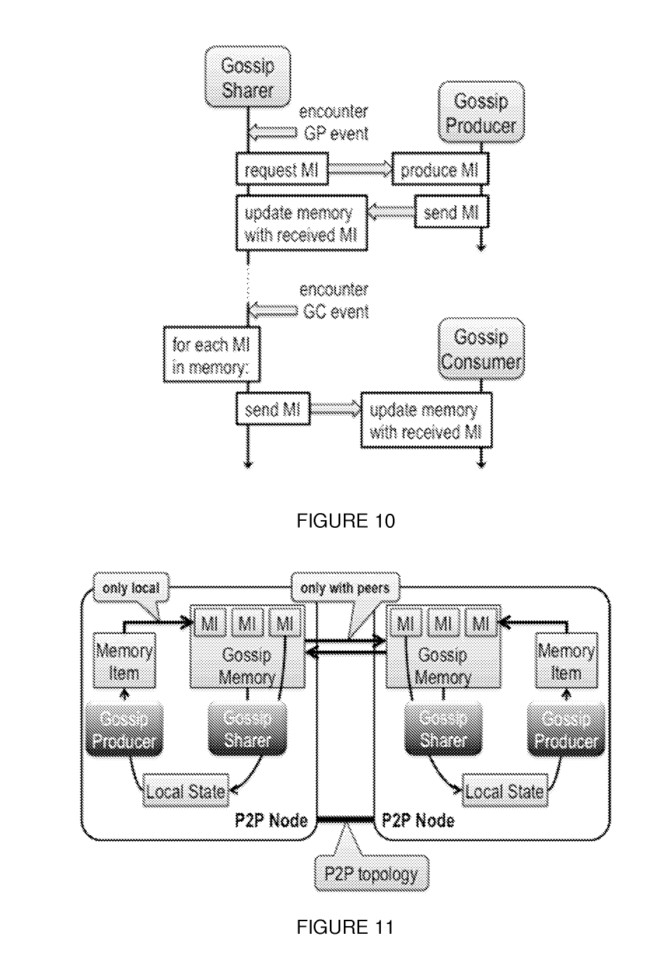

FIG. 9 shows a cyclical version of the process flow of any entity in the GS role (on the left) and interactions with encountered GP and GC triggered by the GS (on the right). In this cyclical version, we assume that the GS process itself decides when to explore its topology environment for GP and GC. If, conversely, there is an external mechanism that generates events when a GP or GC is available for interaction (e.g., a proximity sensor trigger), then the simplified process flow shown in FIG. 10 applies.

Highlighted in FIG. 9 is also the fact that the interaction of the GS with a GP and with a GC both rely on the same MI exchange protocol that communicates an item and then applies all necessary rules by the receiver to update its local memory with the MI.

Gossip Sharer entities continuously extract information from Gossip Producer entities, and, with a delay induced by the any GS movement and information exchange opportunities, deliver it to the Gossip Consumers. In applications, where the information produced by the GP changes rapidly, a delay in the delivery may make it obsolete and even detrimental to the performance of the consumers. For instance, if the GP creates a Memory Item that states its requirement for resource provisioning in the next 5 minutes, any GC that receives that requirement too late (e.g., 3 minutes delay from gossiping plus 3 minutes required for the GC to reach the GP), should not try to act on this request even if it had the required resources available.

Therefore it is necessary for the application developer to consider the gossiping dynamics that emerge from the combination factors such as GS density, perception range, and movement abilities, and ensure that information is removed from the gossiping flow when it becomes obsolete. We define a generic technique based on information aging that the application developer may tune to the specific application scenario.

A Weighted Memory Item (WMI) is an extension of the previously defined MI that carries a scalar “weight” value (limited to (0,1] interval) in addition to the information generated by the Gossip Producer. When the GP first creates a WMI, its weight is initialized to 1. When a WMI is shared with a Gossip Consumer (this includes the Gossipers as the GS role is an extension of the GC role), the weight value is carried forward in the interaction. In the case where the consumer's Gossip Memory already holds a WMI with the same content (other than weight) that is carried in the received WMI, it will discard whichever WMI has the lower weight as the one with the higher weight has the more recent information.

Over time, the weight value of any WMI is decayed at a rate (limited to (0,1] interval) configured by the application developer. The decay is performed by whichever Gossip Consumer holds the WMI (GS and GC entities). If, as a result of the decaying process, the weight falls below a threshold value (also in application configuration), the WMI is removed from the GC's memory.

Depending on the handling of time in the application architecture, different decay strategies may be applied. If, for instance, the GCs are updated at fixed time intervals, the decay rate parameter can be multiplied with the current weight to produce the new weight value in each update cycle. Alternatively, if the GPs and GCs have access to a shared (simulated or real-world) clock, then the WMI should carry a time stamp (T) of its most recent weight update and the decayed weight at time (T+t, t>0) is then computed as: weight(T+t)=weight(T)*rate^{t}

Finally, if no global time synchronization is available (no fixed update frequency, no global clock), then the decay can still be approximated by multiplying the decay rate at frequently occurring events such as GS movement decisions or memory sharing events that transmit a WMI.

### Application in Peer-to-Peer Networks

In this section, we discuss how the present invention is applied to a Peer-to-Peer (P2P network topology. We consider an arbitrary P2P network of (transient) computational nodes linked in a (dynamically changing) communications topology. We are agnostic to the fact that the topology may be formed through the actual communications capabilities of the nodes (e.g., physical sensor network) or as a logical overlay on top of a communications infrastructure (e.g., the internet). Following the specification of the invention, we assign each node while it participates in the P2P network both the Gossip Producer (GP) and Gossip Sharer (GS, includes GC) role. Furthermore, we constrain the perception of the GS role of a given node, such that it interacts with the local GP role and the GS roles of the current immediate peers in the topology (FIG. 11).

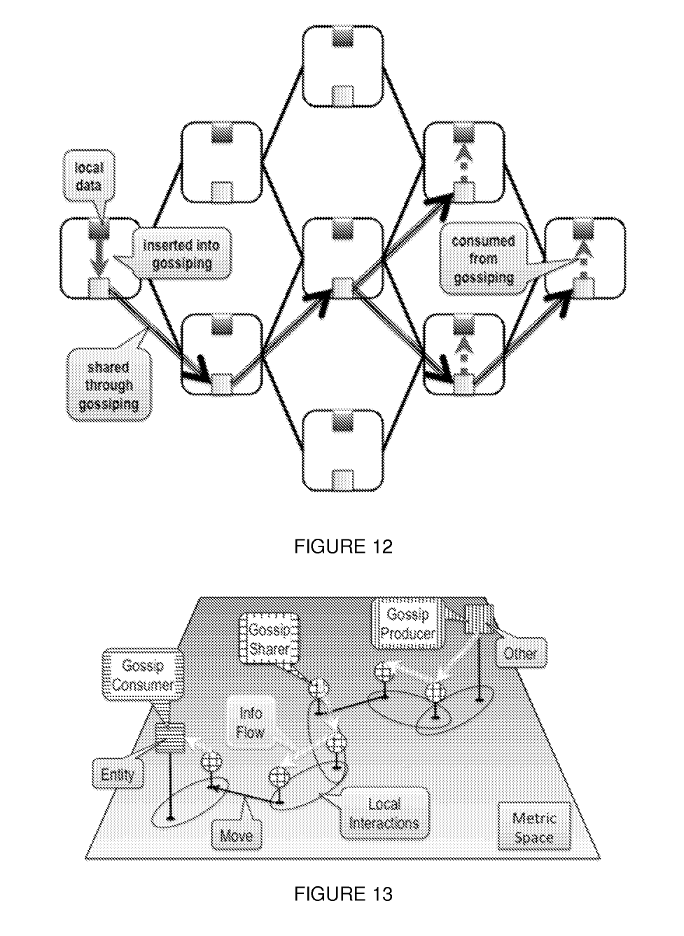

Applying the generic gossiping framework to arbitrary P2P networks provides a general-purpose environment for the transfer of locally generated information across arbitrary distances in the network (as long as a network path exists in the topology) and the local ingest of that information into the state of receiving nodes. FIG. 12 illustrates a possible information flow in a stylized P2P network. The node to the far left generates gossiping information from its local state and inserts it (arrow down) into the gossip sharing flow (between-node arrows). The flow consists of multiple sharing events along the P2P topology. Nodes to the right not only share but also consume (dashed arrow up) the information into their internal state.

The specific rules and data structures that govern the information generation, sharing, and consumption behavior of the nodes are defined by the specific applications that utilize this generic P2P gossiping framework for their specific information transfer needs.

### Application in Metric Spaces

In this section, we discuss how the present invention is applied to a metric space, such as a 2D plane or geographic area. We describe an application-independent population of autonomous agents (“Gossiper”) that take on the GS role, serving as the conduit of the information flow between application-specific entities. To maintain generality, we do not specify whether the Gossiper agents correspond to actual entities in the real-world (e.g., robotic vehicles) or whether they are only virtual entities (mobile agents) in a computational infrastructure. We only require that each Gossiper is embedded in the space shared by the application entities with the ability to perceive them and communicate with them within the distance constraints of the environment.

FIG. 13 illustrates the facilitation of information spreading with the help of Gossiper agents. Note that information spreads in two ways: 1) local interactions among agents, and 2) movement of Gossipers in space.

To apply the application-independent Gossiper agents to the facilitation of a specific information flow, the application developer has to perform the following steps:
1) Identify, which application entities carry (or have access to) information that needs to be made available beyond their limited communications range.
2) Provide each of these entities with the Gossip Producer role, such that they can be identified by the Gossipers (GS role) and be asked to produce a Memory Item (MI).
3) Identify, what information each GP entity needs to share and specialize the MI they produce to carry that information. Encode the transfer (copy) of that information from the GP entity into the MI it produces upon request.
4) Identify, which application entities need to receive information made available by the GP entities.
5) Provide each of these entities with the Gossip Consumer role, such that they can be identified by the Gossipers (GS role) and be asked to receive one or more MI.
6) Encode the transfer (copy) of required information from the MI into the GC entity.

Steps 1-3 concern the information production side while steps 4-6 apply to the consumption of information that was produced.

### REFERENCES

[1] R. Rodrigues and P. Druschel, “Peer-to-peer systems,” Communications of the ACM, vol. 53, no. 10, pp. 72-82, 2010.

1. A method of sharing application-specific information derived from data-items in a distributed and decentralized computational or physical environment, comprising the steps of:
associating application-specific producers of information from data-items with autonomous software agents, each agent being operative to perform independent processes, the processes including a Gossip Producer process;
associating application-specific information intermediaries with autonomous software agents, each agent being operative to perform independent processes, the processes including a Gossip Sharer process;
associating application-specific information consumers with autonomous software agents, each agent being operative to perform independent processes, the processes including a Gossip Consumer process; and
continuously and repeatedly executing the processes by the agents to generate, share, and/or consume information in accordance with the requirements of an application.

2. The method of claim 1, wherein the data-items are application-specific representations of information about physical objects, humans, organizations, events or other real-world entities.

3. The method of claim 1, wherein the data-items are application-specific representations of text, audio, video, sensor data or stored information content.

4. The method of claim 1, including the step of adding or removing the data-items from the environment as corresponding application-specific entities are added to or removed from the application.

5. The method of claim 1, including the step of assigning each agent a position in an application-specific topology.

6. The method of claim 1, wherein the agents have positions in the environment, the method including the step of enabling agents to manipulate their position.

7. The method of claim 5, wherein each agent is able to estimate the distance between its position in the topology relative to another given position value.

8. The method of claim 1, including the step of providing each agent producing information from data-items with access to the current content of its data-item.

9. The method of claim 1, including the step of providing each agent sharing or consuming information originally derived from data-items with an internal ‘Gossip Memory’ data structure.

10. The method of claim 9, wherein the Gossip Memory data structure comprises zero, one, or more ‘Memory Item’ data structures, containing, at a minimum, one or more of the following:
a unique reference to the information producer agent that derived the content of this Memory Item from its accessible data-item,
a topology position stored for the referenced agent, and
a copy of the information derived from the data-item.

11. The method of claim 10, wherein a Memory Item includes a scalar numerical “weight” value to make it a ‘Weighted Memory Item’.

12. The method of claim 8, wherein each agent, defined as “A” and operative to produce information from its associated data-item (“Gossip Producer” process), is further operative to perform the following steps upon request from an information sharing agent (“Gossip Sharer” process) defined as “B”:
(a) create a Memory Item data structure and populate it, at a minimum, with the following information:
(i) a unique reference to A,
(ii) a copy of the current topology position of A, and
(iii) a copy of the current state of the data-item accessible to A; and
(b) add the thus created Memory Item to the Gossip Memory of B.

13. The method of claim 12, wherein the information producing agent creates a Weighted Memory Item instead of a Memory Item and sets its weight value to 1.0

14. The method of claim 8, wherein each agent, defined as “A” and which shares information (“Gossip Sharer” process), is further operative to perform the following steps:
(a) enumerate all other agents that are currently available for direct interaction with agent A, and wherein the availability for each interaction is constrained by the distances among the agents' position in the chosen topology, and wherein these “in-range” entities form A's current Information Source Set {s^{A}₁, s^{A}₂, . . . , s^{A}ₙ};
(b) for each member s^{A}ᵢ of A's Information Source Set that is operative to execute the “Gossip Producer” process:
(i) request a new Memory Item from s^{A}ᵢ as required by an application,
(c) for each member s^{A}ᵢ of A's Information Source Set that is operative to execute the “Gossip Sharer” process:
(i) query s^{A}ᵢ for information about its current content of its Gossip Memory and for each such received Memory Item, add it to agent A's Gossip Memory
(ii) offer s^{A}ᵢ the current content of agent A's Gossip Memory item for optional addition of Memory Items to agent s^{A}ᵢ Gossip Memory; and
(d) for each member s^{A}ᵢ of A's Information Source Set that is operative to execute the “Gossip Consumer” process:
(i) offer s^{A}ᵢ the current content of agent A's Gossip Memory item for optional addition of Memory Items to agent s^{A}ᵢ Gossip Memory.

15. The method of claim 14, wherein the addition of Weighted Memory Items to an agent's Gossip Memory is constrained by the weight value of the Memory Item relative to existing Memory Items referencing the same Gossip Producer agent.

16. The method of claim 9, wherein agents with a Gossip Memory are operative to execute a Memory Management process that repeatedly evaluates and manipulates the Memory Items stored in the agent's memory.

17. The method of claim 16, wherein the Memory Management process ensures through deletion that the number of Memory Items held in the agent's Gossip Memory is not larger than an application-defined limit.

18. The method of claim 17, wherein the weight values of any Weighted Memory Item contained in the agent's Gossip Memory is continuously reduced, for instance through repeated multiplication with a constant factor between zero and one.

19. The method of claim 17 in the realization of claim 18, wherein the choice of which Memory Item to delete to sustain the Gossip Memory size limit is determined by which Weighted Memory Item currently has the smallest weight value.

20. The method of claim 1, wherein the same agent may be operative to execute any combination of the “Gossip Producer”, “Gossip Sharer”, and/or “Gossip Consumer” processes simultaneously.

21. The method of claim 6, wherein the chosen topology is a peer-to-peer graph structure, and wherein each graph node:
is a data-item in the application, and
the topology location of exactly one agent.

22. The method of claim 21, wherein the agent located on a graph node is operative to execute “Gossip Producer”, “Gossip Sharer”, and/or “Gossip Consumer” processes simultaneously.

23. The method of claim 22, wherein the agent's Gossip Sharer process Information Source Set comprises the agents of the graph neighbors (peers) of the agent's node.

24. The method of claim 6, wherein the chosen topology is a metric space and any agent topology location is a coordinate in that space.

25. The method of claim 1, including an application-independent set of agents operative to execute the Gossip Sharer process.

26. The method of claim 6, wherein the application-independent Gossip Sharer agents are operative to execute a movement process in the topology that changes their topology location.

27. The method of claim 26, wherein the movement process is realized as a series of steps in the metric space, where each step determined by the movement process is a vector of limited length added to the current location of the agent.

28. The method of claim 27, wherein each step vector's direction and length is drawn from an application-specific probabilistic process, such as but not limited to, uniform distribution, Gaussian distribution, or a heavy-tailed distribution.
